(19) United States
(12) Patent Application Publication
(10) Pub. No.: US 2025/0135953 A1
(43) Pub. Date: May 1, 2025

(54) CONTROLLING METHOD FOR BATTERY CONDITIONING FOR A MOBILITY APPARATUS AND A MOBILITY APPARATUS OF THE SAME

(71) Applicants: Hyundai Motor Company, Seoul (KR); Kia Corporation, Seoul (KR)

(72) Inventor: Won Jae Lee, Hwaseong-si (KR)

(21) Appl. No.: 18/915,653

(22) Filed: Oct. 15, 2024

(30) Foreign Application Priority Data
Oct. 30, 2023 (KR) 10-2023-0146852

(51) Int. Cl. B60L 58/22; B60L 58/12; B60L 58/16; B60L 58/26; B60L 58/27; H01M 10/42

(52) U.S. Cl. CPC B60L 58/22; B60L 58/12; B60L 58/26; B60L 58/27; H01M 10/425; B60L 58/16; B60L 2210/10; B60L 2240/425; H01M 2010/4271; H01M 2220/20

(57) ABSTRACT

An embodiment mobility apparatus includes a plurality of wheels, at least one driving motor configured to provide driving force to the wheels, a first battery configured to supply power to the at least one driving motor, and a controller configured to control the at least one driving motor and the first battery, wherein, in a state in which a second battery is detachably electrically connected to the first battery through a DC/DC converter, the controller is configured to perform a prioritized mode among a plurality of modes for battery conditioning control to be performed first based on states of the first battery and the second battery to carry out the battery conditioning control.

### CROSS-REFERENCE TO RELATED APPLICATIONS

This application claims the benefit of Korean Patent Application No. 10-2023-0146852, filed on Oct. 30, 2023, which application is hereby incorporated herein for all purposes by this reference.

### TECHNICAL FIELD

The present disclosure relates to a mobility apparatus and a method of performing battery conditioning control therefor.

### BACKGROUND

The statements in this section merely provide background information related to embodiments of the present disclosure and may not constitute already known prior art.

Generally, electric vehicles, a type of mobility apparatus, are driven with their wheels driven by a driving force of a driving motor.

In addition, it is common for a high voltage battery to be fixed to and mounted on the vehicle to supply power to the driving motor.

The driving motor may be an AC motor, so an inverter may be arranged between the battery and the driving motor.

When the battery of an electric vehicle requires charging according to its state of charge (SOC), it is charged by receiving external power through an on-board charger (OBC).

The time required for charging an electric vehicle is determined depending on the charging method, and there are two main types of charging: slow charging and fast charging.

By virtue of continuous research and development on batteries, in recent days, the driving range per charge has been significantly improved.

However, the battery fixed to and mounted on the battery of an electric vehicle may still be insufficient, so an alternative is needed.

The information included in this background section is only for enhancement of understanding of the general background of embodiments of the present disclosure and may not be taken as an acknowledgement or any form of suggestion that this information forms the already known prior art.

### SUMMARY

Embodiments of the present disclosure can resolve problems in the art.

Embodiments of the present disclosure provide a new concept of using a second high voltage battery that can be attached to and detached from the power system of an electric vehicle as needed in addition to a first high voltage battery that has been already installed in the electric vehicle.

In addition, one embodiment of the present disclosure provides a method of performing conditioning control for the two batteries with the second high voltage battery connected and an electric vehicle to which the method is applied.

Because conventional electric vehicles have a single battery system, conditioning control therefor can be carried out in a simple manner. However, a dual battery system including a first high voltage battery and a second high voltage battery poses various risks related to batteries, such as an excessively high temperature, a low temperature, over-charge, and over-discharge, so that battery life may be shortened, causing a decrease in battery performance. One embodiment of the present disclosure prevents the life of the system from being shortened through conditioning control in response to such risks related to batteries.

The mobility apparatus according to an embodiment of the present disclosure may include a plurality of first wheels, at least one first driving motor configured to provide a driving force to the plurality of first wheels, a first battery configured to supply power to the at least one first driving motor, and a first controller configured to control the at least one first driving motor and the first battery. When a second battery is electrically and detachably connected to the first battery through a DC/DC converter, the first controller may be configured to perform a prioritized mode among a plurality of modes for battery conditioning control to be performed first based on states of the first battery and the second battery to carry out the conditioning control.

According to at least one embodiment of the present disclosure, the performing of a prioritized mode among a plurality of modes for battery conditioning control includes examining the respective states and/or an integrated state of the first battery and the second battery.

According to at least one embodiment of the present disclosure, the examining of the respective states and/or an integrated state includes examining the states based on a first SoC and a first temperature of the first battery and a second SoC and a second temperature of the second battery.

According to at least one embodiment of the present disclosure, the examining of the states based on a first SoC and a first temperature of the first battery and a second SoC and a second temperature of the second battery includes giving a flag value to each of a flag for the first SoC (MS), a flag for the first temperature (MT), a flag for the second SoC (SS), and a flag for the second temperature (ST).

According to at least one embodiment of the present disclosure, the flag values of the MS and the SS include values each corresponding to being normal, being over-charged, and being over-discharged, and the flag values of the MT and the ST include values each corresponding to a normal temperature, an excessively high temperature, and a low temperature.

According to at least one embodiment of the present disclosure, the giving of a flag value to each of a flag for the first SoC (MS), a flag for the first temperature (MT), a flag for the second SoC (SS), and a flag for the second temperature (ST) includes correcting the flag value of the MS or the SS so that both the MS and the SS are given the value corresponding to being over-charged when the examination of the respective states shows that either the MS or the SS is given the value corresponding to being over-charged and the examination of the integrated state shows that the sum of the first SoC and the second SoC is greater than the sum of a set first SoC over-charge threshold and a set second SoC over-charge threshold, and/or correcting the flag value of the MS or the SS so that both the MS and the SS are given the value corresponding to being over-discharged when the examination of the respective states shows that one of the MS and the SS is given the value corresponding to being over-discharged while the other is given the value corresponding to being normal and the examination of the integrated state shows that the sum of the first SoC and the second SoC is less than the sum of a set first SoC over-discharge threshold and a set second SoC over-discharge threshold.

According to at least one embodiment of the present disclosure, the plurality of modes may include at least two of a first mode for conditioning control applied when at least one of the MS and the SS is given the value corresponding to being overcharged, a second mode for conditioning control applied when at least one of the MS and the SS is given the value corresponding to being over-discharged, a third mode for conditioning control applied when at least one of the MT and the ST is given the value corresponding to an excessively high temperature, and a fourth mode for conditioning control applied when at least one of the MT and the ST is given the value corresponding to a low temperature.

According to at least one embodiment of the present disclosure, the first mode includes control for charging and discharging between the first battery and the second battery, targeting an average value of the first SoC and the second SoC, when both the MS and the SS are given the value corresponding to being overcharged, and/or control for discharging, targeting a set overcharge release SoC, one which is given the value corresponding to being overcharged among the first battery and the second battery to the other one, when either the MS or the SS is given the value corresponding to being overcharged.

According to at least one embodiment of the present disclosure, the overcharge release SoC is determined based on the SoC-SoH-temperature data set for the one given the value corresponding to being overcharged.

According to at least one embodiment of the present disclosure, the second mode includes control for transmitting a signal for requesting charging to a user interface when both the MS and the SS are given the value corresponding to being over-discharged, and/or control for charging, targeting an over-discharge release SoC, one which is given the value corresponding to being over-discharged among the first battery and the second battery from the other one, when either the MS or the SS is given the value corresponding to being over-discharged.

According to at least one embodiment of the present disclosure, the over-discharge release SoC may be determined based on the SoC-SoH-temperature data set for the battery given the value corresponding to being over-discharged.

According to at least one embodiment of the present disclosure, the third mode includes control for cooling the first battery and the second battery to a set excessively-high-temperature release temperature or an ambient temperature using power of the first battery and the second battery when both the MT and the ST are given the value corresponding to an excessively high temperature, and/or control for cooling one of the first battery and the second battery to the excessively-high-temperature release temperature or the ambient temperature using power of the other one which is not given the value corresponding to an excessively high temperature when only one among the MT and the ST is given the value corresponding to an excessively high temperature.

According to at least one embodiment of the present disclosure, the excessively-high-temperature release temperature may be determined based on the SoC-SoH-temperature data set for the battery given the value corresponding to an excessively high temperature.

According to at least one embodiment of the present disclosure, the fourth mode includes control for heating the first battery and the second battery to a set low-temperature release temperature or an ambient temperature using power of the first battery and the second battery when both the MT and the ST are given the value corresponding to a low temperature, and/or control for heating one among the first battery and the second battery to the low-temperature release temperature or the ambient temperature using power of the other one which is not given the value corresponding to a low temperature when either the MT or the ST is given the value corresponding to a low temperature.

According to at least one embodiment of the present disclosure, the low-temperature release temperature may be determined based on the SoC-SoH-temperature data set for the battery given the value corresponding to a low temperature.

According to at least one embodiment of the present disclosure, the performing of a prioritized mode among a plurality of modes for battery conditioning control includes updating the values of the MT, the MS, the ST, and the SS and performing a subsequent mode based on the updated values after the prioritized mode, wherein after the first mode has been carried out, the third mode is selected as a subsequent mode when at least one of the updated MT and ST is not given the value corresponding to a normal temperature, and the second mode is selected as a subsequent mode when neither the updated MS nor SS is given the value corresponding to being overcharged, after the second mode has been carried out, the third mode is selected as a subsequent mode when at least one of the updated MT and ST is not given the value corresponding to a normal temperature, and the conditioning control ends when all of the updated MT, ST, MS, and SS are given the value corresponding to being normal, after the third mode has been carried out, the fourth mode is selected as a subsequent mode when at least one of the updated MT and ST is given the value corresponding to a low temperature, and the second mode is selected as a subsequent mode when both the updated MT and ST are given the value corresponding to a normal temperature, and after the fourth mode has been carried out, the third mode is selected as a subsequent mode.

According to at least one embodiment of the present disclosure, the performing of a prioritized mode among a plurality of modes for battery conditioning control includes determining the prioritized mode, and wherein the determining of the prioritized mode includes a first decision where, when the absolute value of the difference between the temperature of the battery given the flag value corresponding to a low temperature among the MT and the ST and the ambient temperature is less than the absolute value of the difference between the temperature of the battery given the flag value corresponding to an excessively high temperature among the MT and the ST and the ambient temperature, the fourth mode is selected as the mode to be first performed, otherwise, the third mode is selected as the mode to be first performed, a second decision, where, after the first decision has been made, when the sum of the available SoC of the first battery and the available SoC of the second battery is less than the SoC expected to be required for the conditioning control, the mode to be first performed is switched to the second mode, otherwise, the first decision is maintained, and a third decision, where, after the second decision has been made, when the ambient temperature is above the optimal temperature range set for the first battery and/or the second battery, the mode to be first performed is switched to the first mode, otherwise, the second decision is maintained.

According to an embodiment of the present disclosure, a method of performing battery conditioning control for a mobility apparatus may be provided, and the mobility apparatus may include a plurality of first wheels, at least one first driving motor configured to provide driving force to the plurality of first wheels, a first battery configured to supply power to the at least one first driving motor, and a first controller configured to control the at least one first driving motor and the first battery, wherein the method may include, when a second battery is electrically and detachably connected to the first battery through a DC/DC converter, performing, by the first controller, a prioritized mode among a plurality of modes for battery conditioning control based on states of the first battery and the second battery to carry out the conditioning control.

According to at least one embodiment of the present disclosure, the performing of a prioritized mode among a plurality of modes for battery conditioning control includes examining the respective states and/or an integrated state of the first battery and the second battery.

A mobility apparatus according to an embodiment of the present disclosure may be detachably connected to a first mobility apparatus including a plurality of first wheels, at least one first driving motor configured to provide driving force to the plurality of first wheels, a first battery configured to supply power to the at least one first driving motor, and a first controller configured to control the at least one first driving motor and the first battery. The mobility apparatus may include a second battery detachably and electrically connected to the first battery and a second controller, wherein, when the second battery is electrically connected to the first battery through a DC/DC converter, the second controller is configured to perform a prioritized mode among a plurality of modes for battery conditioning control based on states of the first battery and the second battery to carry out the conditioning control.

According to embodiments of the present disclosure, it may be possible to extend the driving range of electric vehicles and improve their usability by removably connecting the second high voltage battery to their power system.

In addition, according to embodiments of the present disclosure, it may be possible to respond appropriately to various risks related to batteries of a dual battery system, such as an excessively high temperature, a low temperature, overcharge, and over-discharge, through conditioning control, preventing the life of the battery system from being shortened.

The methods and apparatuses of embodiments of the present disclosure have other features and advantages which will be apparent from or are set forth in more detail in the accompanying drawings, which are incorporated herein, and the following detailed description, which together serve to explain certain principles of embodiments of the present disclosure.

### BRIEF DESCRIPTION OF THE DRAWINGS

FIG. 1 shows the power system of a first mobility apparatus according to an embodiment of the present disclosure.

FIG. 2 shows how a second mobility apparatus is connected to the first mobility apparatus according to an embodiment of the present disclosure.

FIG. 3 shows the control process according to an embodiment of the present disclosure.

FIG. 4 shows how the respective states of a first high voltage battery and a second high voltage battery are examined during the process in FIG. 3.

FIG. 5 shows how a mode to be first performed is determined during the process in FIG. 3.

FIG. 6 conceptually shows the SoC-SoH-temperature map for the first high voltage battery and/or the second high voltage battery.

FIG. 7 shows how conditioning control is carried out during the process in FIG. 3.

FIGS. 8A and 8B illustrate flag values and corresponding modes determined based on the respective states of the first high voltage battery and the second high voltage battery according to an embodiment of the present disclosure.

It may be understood that the appended drawings are not necessarily to scale, presenting a somewhat simplified representation of various features illustrative of the basic principles of embodiments of the present disclosure. The specific design features of embodiments of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawings.

### DETAILED DESCRIPTION OF ILLUSTRATIVE EMBODIMENTS

Because various changes can be made to the present disclosure and a range of embodiments can be made for the present disclosure, specific embodiments will be illustrated and described in the drawings. However, this is not intended to limit the present disclosure to the specific embodiments, and it should be understood that the present disclosure includes all changes, equivalents, and substitutes within the technology and the scope of the present disclosure.

The terms “module” and “unit” used in the present disclosure are merely used to distinguish the names of components and should not be interpreted as assuming that the components have been physically or chemically separated or can be so separated.

Terms containing ordinal numbers such as “first” and “second” may be used to describe various components, but the components are not limited by the terms. The above-mentioned terms can be used only as names to distinguish one component from another component, and the order therebetween can be determined by the context in the descriptions thereof, not by such names.

The expression “and/or” is used to include all possible combinations of multiple items being addressed. For example, by “A and/or B,” all three possible combinations are meant: “A,” “B,” and “A and B.”

When a component is said to be “coupled” or “connected” to another component, it means that the component may be directly coupled or connected to the other component or there may be other components therebetween.

The terms used herein are only used to describe specific embodiments and are not intended to limit the present disclosure. Expressions in the singular form include the meaning of the plural form unless they clearly mean otherwise in the context. In the present disclosure, expressions such as “comprise” or “have” are intended to indicate the presence of features, numbers, steps, operations, components, parts, or combinations thereof described herein, and they should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the technical field to which the present disclosure pertains. Terms defined in commonly used dictionaries should be interpreted as having meanings consistent with the meanings they have in the context of the relevant technology, and they should not be interpreted in an ideal or overly formal sense unless explicitly defined in the present disclosure.

In addition, a unit, a control unit, a control device, or a controller is only a term widely used to name devices for controlling a certain function, and they do not mean a generic function unit. For example, devices with these names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

Meanwhile, the processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of a computer-readable recording medium (or simply called a memory) may include all types of storage devices for storing data that can be read by a computer system. For example, they may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a recording medium may be electrically connected to the processor, and the processor may load and write data from the recording medium. The recording medium and the processor may be integrated or may be physically separate.

Hereinafter, the attached drawings will be briefly described, and, with reference to the drawings, the embodiments of the present disclosure will be described in detail.

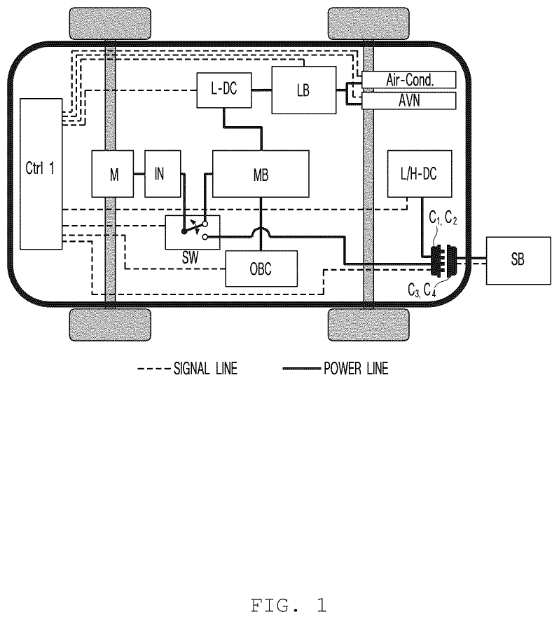

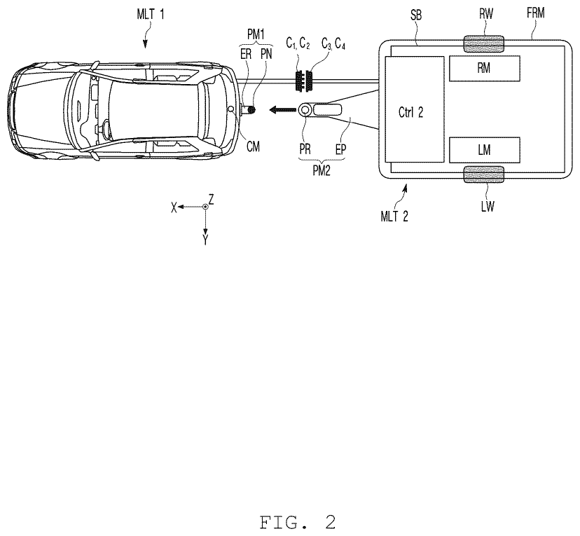

FIG. 1 conceptually shows the power system of a first mobility apparatus MLT 1 (e.g., an electric vehicle) according to an embodiment of the present disclosure, and FIG. 2 shows how a second mobility apparatus MLT 2 is connected to the first mobility apparatus MLT 1.

With reference to FIGS. 1 and 2, the structure of each of the first mobility apparatus MLT 1 and the second mobility apparatus MLT 2 according to an embodiment of the present disclosure will be described.

As shown in FIG. 1, the first mobility apparatus MLT 1 according to an embodiment of the present disclosure is, for example, an electric vehicle, and may include a first driving motor M, an inverter IN, a first high voltage battery MB, an on-board charger OBC, a first DC/DC converter L-DC, a low voltage battery LB, an air-conditioning device Air-Cond. and an audio video navigation AVN, which operate at low voltage, a second DC/DC converter L/H-DC, a switch SW, and a controller Ctrl 1 (hereinafter, referred to as a “first controller”).

The first driving motor M may provide a driving force to the wheels of a vehicle and may be an AC motor for example.

The inverter IN may convert a direct current power supplied to the first driving motor M into alternating current.

The first high voltage battery MB may be fixed to and installed in the body of the first mobility apparatus MLT 1, for example, under the floor of the passenger compartment.

The main function of the first high voltage battery MB may be to supply electric power to the first driving motor M and can be charged with the on-board charger OBC.

In addition, the first high voltage battery MB may be connected to the low voltage battery LB through the first DC/DC converter L-DC to charge the low voltage battery LB.

For charging the low voltage battery LB, the first DC/DC converter L-DC may be a low-voltage DC-DC converter LDC.

The low voltage battery LB may be, for example, a 12 V or 24 V battery, and it may supply electric power to electrical devices in a vehicle, such as the air-conditioning device Air-Cond. and the AVN, which operate at low voltage.

A second high voltage battery SB shown in FIG. 1 may be installed in the second mobility apparatus MLT 2, but it is not necessarily limited thereto. For example, the second high voltage battery SB may be detachably installed in the first mobility apparatus MLT 1.

The second high voltage battery SB may be additionally connected to a vehicle's power system including the first high voltage battery MB. That is, the second high voltage battery SB may be detachably and electrically connected to the power system by wire (or wirelessly within possible range) in a manner that the absence of the second high voltage battery SB has no effect on the operation of the power system (power supply to electronics, a driving motor, etc. of a vehicle).

In addition, the second high voltage battery SB may be referred to as a replaceable battery, an auxiliary battery, an extended battery, or a secondary battery, but this is only to distinguish the second high voltage battery SB from the first high voltage battery MB. In other words, anything regarding the second high voltage battery SB, such as the functions, the features, its own mechanical/electrical/chemical structure or that in relationship with other objects (including the first high voltage battery MB, a host vehicle, etc.), the type of battery (including a packaging method and the type of anode material, cathode material, separator, etc.), and the charging method, is not limited by what it is called.

It may be possible for the second high voltage battery SB to communicate with the first controller Ctrl 1 of the first mobility apparatus MLT 1 or a battery management system (BMS) of the first high voltage battery MB, which will be described below, by wire or wirelessly, so that various sensing information (e.g., voltage, current, temperature, etc.) related to the state of charge (SoC) and the physical/electrical/chemical state of the second high voltage battery SB may be transmitted to the first controller Ctrl 1. However, not necessarily limited thereto, the above-mentioned information related to the second high voltage battery SB may also be transmitted to the first controller Ctrl 1 through a second controller Ctrl 2 of the second mobility apparatus MLT 2, which will be described below.

According to this embodiment of the present disclosure, the high voltage battery applied to the first high voltage battery MB and the second high voltage battery SB may include, for example, a plurality of battery cells (not shown) outputting a voltage of 2.7 to 4.2 V, and a set number of battery cells may be connected in series/parallel to each other to form one module. The high voltage battery may be in the form of one or more battery modules connected to each other in series/parallel and thus packaged in one battery package to output a desired voltage, e.g., a voltage of about 400 V, about 800 V, or several kV.

The first high voltage battery MB and the second high voltage battery SB may each include the BMS.

The BMS may include a battery management unit (BMU), a cell monitoring unit (CMU), and a battery junction box (BJB).

The BMS may perform a cell balancing function to ensure the performance of the entire battery pack by maintaining the voltage of each cell constant, a SoC function to calculate the capacity of the entire battery system, and a control function of battery cooling, charging, and discharge, etc.

The BMU may receive information on each cell from the CMU and fulfill the functions of the BMS based thereon.

For example, the BMU may include two micro control units (MCUs), and each MCU may have one CAN communication port. A CAN interface may be included for the communication with a vehicle controller, which can be said to be the upper device of the BMS, and a CAN interface may be included to collect information from the CMU, which is the lower device thereof.

The CMU may be directly attached to a battery cell and may monitor voltage, current, temperature, etc. The CMU may not perform calculations related to the BMS algorithm and may only serve to monitor. One CMU may be connected to multiple battery cells and may transmit information on each cell to the BMU through a CAN interface.

The BJB may be the mechanism for determining the pack-level of the BMS and the medium that connects the high voltage battery and the drivetrain. The BJB may measure and record a battery's voltage and the current flowing in and out of the battery to accurately calculate the SoC. In addition, the BJB may perform important functions for safety, such as monitoring of insulation as well as detecting of overcurrent.

The second high voltage battery SB may be a high-voltage battery with a lower voltage than the first high voltage battery MB, and, in this case, the second DC/DC converter L/H-DC may be a DC/DC converter for voltage boosting. In contrast, the second high voltage battery SB may be a high-voltage battery with a higher voltage than the first high voltage battery MB, and, in this case, the second DC/DC converter L/H-DC may be a DC/DC converter for step-down. In addition, according to this embodiment, the second DC/DC converter L/H-DC may be a bidirectional converter, so it may be possible for the first high voltage battery MB and the second high voltage battery SB to charge and discharge each other.

According to this embodiment of the present disclosure, the second DC/DC converter L/H-DC may be built into the first mobility apparatus MLT 1 in the power system, but it is not limited thereto. For example, unlike this embodiment, the second DC/DC converter L/H-DC may be provided as a separate component and may be additionally and detachably connected to the power system. In addition, the second DC/DC converter L/H-DC may be built into or detachably included in the second mobility apparatus MLT 2.

According to this embodiment of the present disclosure, for the detachable and electrical connection to the power system of the second high voltage battery SB, the power system of the first mobility apparatus MLT 1 may include first and second connectors C1 and C2, and the second high voltage battery SB may include third and fourth connectors C3 and C4.

For example, the first and second connectors C1 and C2 may be in the form of one integrated connector, and the third and fourth connectors C3 and C4 may also be in the form of one integrated connector.

The first connector C1 may be connected to the second DC/DC converter L/H-DC, and the second connector C2 may be connected to the switch SW.

Meanwhile, although not shown, it is needless to say that a connector for transmitting signals may be added to transmit various sensing and state information on the second high voltage battery SB to the controller.

The switch SW may be fixed to and electrically connected to the inverter IN, and it may be turned on between the first high voltage battery MB and the second connector C2 to electrically connect the inverter IN and the first high voltage battery MB or the inverter IN and the second high voltage battery SB.

According to this embodiment, the first high voltage battery MB may be connected to the inverter IN through the switch SW, though it is not necessarily limited thereto, and it may also be connected directly to the inverter IN without the switch SW. In this case, of course, the second connector and the fourth connector of the second high voltage battery SB may not be needed.

In addition, according to this embodiment of the present disclosure, the first controller Ctrl 1 may be the highest-level vehicle controller that controls all electric devices of the first mobility apparatus MLT 1, but it is not necessarily limited thereto. That is, for example, the first controller Ctrl 1 in FIG. 1 may be a power controller subordinate to a vehicle controller.

Furthermore, as described above, the first controller Ctrl 1 according to this embodiment may include computer-readable recording media that store operating systems, logic instructions, input/output information, etc. and one or more processors that read them and perform the operation of making determinations and decisions, doing calculations, etc. to control the functions.

The second high voltage battery SB in FIG. 1 may be installed in the second mobility apparatus MLT 2 as shown in FIG. 2.

The second mobility apparatus MLT 2 may include a frame FRM, a second left wheel LW installed on the left side of the frame FRM, a second right wheel RW installed on the right side of the frame FRM, a second left driving motor LM for providing a driving force to the second left wheel LW, a second right driving motor RM for providing a driving force to the second right wheel RW, and the second controller Ctrl 2.

The second high voltage battery SB may be fixed to and installed in the second mobility apparatus MLT 2, but it is not necessarily limited thereto. That is, the second high voltage battery SB may be detachably installed in the second mobility apparatus MLT 2. As a result, it may be possible to replace the second high voltage battery SB mounted on the frame FRM with the SoC of being fully discharged with a new second high voltage battery SB with the SoC of being fully charged.

When the second high voltage battery SB is fixed to and installed in the second mobility apparatus MLT 2, the second mobility apparatus MLT 2 may include a charging connector for charging the second high voltage battery SB.

The frame FRM may form the exterior of the second mobility apparatus MLT 2 and may serve to accommodate other components.

The frame FRM may include a second pivot mechanism PM2 as a second connection mechanism, and the second pivot mechanism PM2 may be detachably and pivotably connected to a first pivot mechanism PM1, which is a first connection mechanism fixed to the body of the first mobility apparatus MLT 1.

For example, the first pivot mechanism PM1 may include an extension rod ER extending rearwardly from the body of the first mobility apparatus MLT 1 and a pivot pin PN protruding upward from an end of the extension rod ER.

In addition, the second pivot mechanism PM2 may include a triangular-shaped extension portion EP protruding forward from the frame FRM of the second mobility apparatus MLT 2 and a pivot ring PR into which the pivot pin PN may be rotatably inserted at the end of the extension portion EP.

When the pivot pin PN is inserted into the pivot ring PR, the linear movement of the pivot pin PN may be limited, and it may only rotate in the Z-axis direction in FIG. 2. Therefore, when the second mobility apparatus MLT 2 is pivotably connected, the linear movement of the second mobility apparatus MLT 2 may be limited about the pivot connection point with respect to the first mobility apparatus MLT 1, and the second mobility apparatus MLT 2 may only rotate about the Z axis.

When driving in the forward direction, that is, in the X-axis direction, the first mobility apparatus MLT 1 and the second mobility apparatus MLT 2 may remain in a straight line even without separate control of the steering of the second mobility apparatus MLT 2.

According to this embodiment, the pivot mechanisms as the first and second connection mechanisms may be included, but it is not necessarily limited thereto. For example, the first and second connection mechanisms may be well-known mechanisms that enable non-rotational connection about the Z axis.

The rotation axis of the second left driving motor LM may be connected to the second left wheel LW so that the second left driving motor LM may supply a driving force to the second left wheel LW.

In addition, the rotation axis of the second right driving motor RM may be connected to the second right wheel RW so that the second right driving motor RM may supply a driving force to the second right wheel RW.

Because the second left wheel LW and the second right wheel RW may respectively be connected to the second left driving motor LM and the second right driving motor RM, it may be possible to drive them independently of each other.

It may be possible to drive the second left driving motor LM and the second right driving motor RM in the forward and reverse directions. When they are driven in the forward direction, the second mobility apparatus MLT 2 may travel forward, and, when they are driven in the reverse direction, it may travel backwards.

For example, the second left driving motor LM and the second right driving motor RM may each be designed as an in-wheel driving system where a driving motor is installed within a wheel, but they are not necessarily limited thereto.

In addition, unlike this embodiment, the second mobility apparatus MLT 2 may be driven in the manner that the left and right sides of the second mobility apparatus MLT 2 are not independent of each other and the power of one common motor is divided and transmitted to the second left wheel LW and the second right wheel RW. To this end, a differential gear may be disposed between a common second driving motor and the second left wheel LW and the second right wheel RW. That is, the power of the common second driving motor may be distributed to the second left wheel LW and the second right wheel RW by the differential gear. In this case, a torque vectoring means may be added to distribute torque among the second left wheel LW and the second right wheel RW.

Referring to FIG. 2, the second controller Ctrl 2 may control the second left driving motor LM and the second right driving motor RM to allow the second mobility apparatus MLT 2 to travel forward and backward. In addition, when the steering of the second mobility apparatus MLT 2 is required, the second controller Ctrl 2 may control the torque or the number of rotations of each of the second left driving motor LM and the second right driving motor RM to change the direction in which the second mobility apparatus MLT 2 travels. That is, the driving of the second left driving motor LM and the second right driving motor RM may be separately controlled, so that it may be possible to achieve the steering of the second mobility apparatus MLT 2 without a separate steering device.

In addition, as described above, a wired or wireless communication means for transmitting information between the connectors in FIG. 1 and the first and second mobility apparatuses MLT 1 and MLT 2 may be included.

Meanwhile, according to this embodiment, the first controller Ctrl 1 or the second controller Ctrl 2 may include a memory and a processor. Computer instructions for performing the functions of a corresponding controller may be stored in the memory, and the processor may perform the above-mentioned functions by loading the instructions from the memory and executing them.

For example, the memory may include at least one of a hard disk drive (HDD), a solid-state drive (SSD), a silicon disk drive (SDD), a ROM, a RAM, a CD-ROM, a magnetic tape, a floppy disk, and an optical data storage device.

In addition, for example, the processor may include at least one of a computer, a microprocessor, a central processing unit (CPU), an ASIC, an electric circuit, and a logic circuit.

The first and second connectors C1 and C2 of the first mobility apparatus MLT 1 and the third and fourth connectors C3 and C4 of the second mobility apparatus MLT 2 may be connected to each other, and the connector for transmitting signals may be connected, so that it may be possible that the first mobility apparatus MLT 1 and the second mobility apparatus MLT 2, that is, the first controller Ctrl 1 and the second controller Ctrl 2, communicate with each other.

When the first mobility apparatus MLT 1 starts to drive forward with the first mobility apparatus MLT 1 and the second mobility apparatus MLT 2 mechanically and electrically connected to each other, according to the signal of the driving speed transmitted from the first connector C1, the second controller Ctrl 2 may control the second left driving motor LM and the second right driving motor RM to enable the second mobility apparatus MLT 2 to drive straight ahead.

In that case, some or all of the speed, the position of the gear, the steering angle, the information on an accelerator pedal sensor (APS), and the information on a brake pedal sensor (BPS) of the first mobility apparatus MLT 1 may be transmitted to the second mobility apparatus MLT 2.

For example, the second controller Ctrl 2 of the second mobility apparatus MLT 2 may determine whether the first mobility apparatus MLT 1 is traveling forward or backward, based on some or all of the speed, the position of the gear, the information on an accelerator pedal sensor (APS), and the information on a brake pedal sensor (BPS) of the first mobility apparatus MLT 1. However, the present disclosure is not limited thereto, and it goes without saying that the second controller Ctrl 2 of the second mobility apparatus MLT 2 may receive the information on whether the first mobility apparatus MLT 1 is traveling forward or backward directly from the first controller Ctrl 1.

When the first mobility apparatus MLT 1 is traveling forward, the second controller Ctrl 2 may drive the second left driving motor LM and the second right driving motor RM in the forward direction to allow the second mobility apparatus MLT2 to drive straight ahead. Furthermore, when the first mobility apparatus MLT 1 is traveling backward, the second controller Ctrl 2 may drive the second left driving motor LM and the second right driving motor RM in the reverse direction to allow the second mobility apparatus MLT2 to drive backward.

In addition, the second controller Ctrl 2 may determine how the first mobility apparatus MLT 1 is being steered based on information on the steering angle of the first mobility apparatus MLT 1, and it may steer the second mobility apparatus MLT 2 accordingly.

The second mobility apparatus MLT 2 may not include a separate steering device such as a steering wheel and a steering rack, and it may be possible to steer the second mobility apparatus MLT 2 by controlling the torque of the second left driving motor LM and the second right driving motor RM.

That is, the second controller Ctrl 2 may calculate a driving torque for driving and a steering torque for steering for each of the second left driving motor LM and the second right driving motor RM to perform the control operation.

For example, for the steering of the second mobility apparatus MLT 2, the steering torque values of the second left driving motor LM and the second right driving motor RM according to the steering angle of the first mobility apparatus MLT 1 may be included in a lookup table or a calculation program.

When the second mobility apparatus MLT 2 drives straight ahead, the speed of the second mobility apparatus MLT 2 may be controlled to be no greater than that of the first mobility apparatus MLT 1. As a result, the pivot connection between the first mobility apparatus MLT 1 and the second mobility apparatus MLT 2 may be maintained at a pivot angle within a predetermined range. For example, when the speed of the second mobility apparatus MLT 2 driving straight ahead is controlled to be no greater than that of the first mobility apparatus MLT 1, at the pivot connection point, the pivot angle between the second mobility apparatus MLT 2 and the first mobility apparatus MLT 1 may be maintained at 0 degree, i.e., the angle where the first mobility apparatus MLT 1 and the second mobility apparatus MLT 2 are in a straight line.

When the second mobility apparatus MLT 2 is driving forward, it may be controlled to follow the first mobility apparatus MLT 1, so that the driving of multiple mobility apparatuses connected to each other may be smoothly performed.

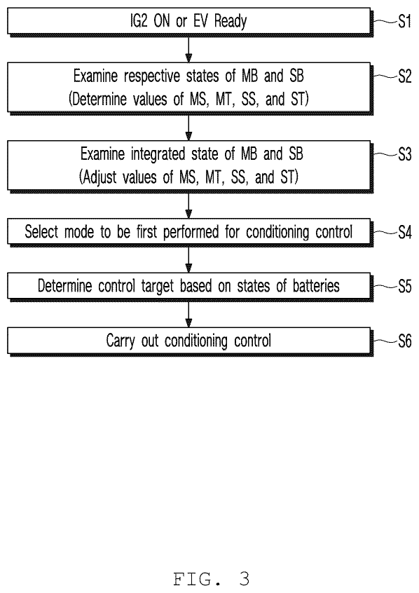

Hereinafter, with reference to FIG. 3, the process of controlling conditioning of a battery according to an embodiment of the present disclosure will be described.

The process in FIG. 3 may be performed by the first controller Ctrl 1 or the second controller Ctrl 2, but, in this embodiment, for convenience of description, the process performed by the first controller Ctrl 1 will be described.

First, at S1, the power mode of the first mobility apparatus MLT 1 may be the “IG2 ON” mode or the “EV Ready” mode.

Examples of the power mode may include the IG1, IG2, and EV Ready modes.

In the state of IG1 ON, the corresponding switches of the related relays may have been turned on so that power can be supplied to designated electronic devices not related to driving, including convenience devices in a vehicle, such as an air conditioning system and an AVN.

In the state of IG2 ON, the corresponding switches of the related relays may have been turned on so that power can be supplied to all electronic devices in a vehicle, including various controllers.

In addition to the state of IG2 ON, the state of EV Ready may be a mode in which a vehicle control unit may have turned capable of starting driving at any time according to signals sensed by an accelerator pedal sensor (APS) and/or a brake pedal sensor (BPS).

The first controller Ctrl 1 may examine the respective states of the first high voltage battery MB and the second high voltage battery SB at S2. It is needless to say that the BMS in each battery may be used to determine the states.

The first controller Ctrl 1 may give values to flags for the respective states of the first high voltage battery MB and the second high voltage battery SB at S2.

According to this embodiment, the flag related to the SoC (hereinafter, referred to as a “first SoC”) of the first high voltage battery MB is referred to as “MS,” the flag related to the temperature (hereinafter, referred to as a “first temperature”) of the first high voltage battery MB is referred to as “MT,” the flag related to the SoC (hereinafter, referred to as a “second SoC”) of the second high voltage battery SB is referred to as “SS,” and the flag related to the temperature (hereinafter, referred to as a “second temperature”) of the second high voltage battery SB is referred to as “ST.”

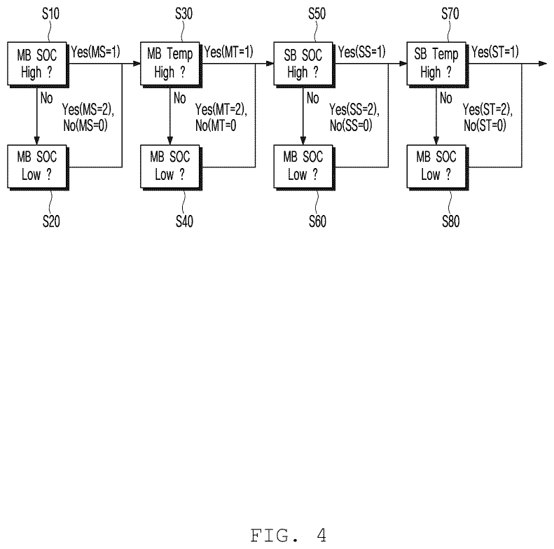

FIG. 4 shows how the respective states of the two batteries are examined and the values of the flags therefor are determined, which will be described below.

First, according to this embodiment, as the values of MS and SS, “0” means being normal, “1” means being overcharged, and “2” means being over-discharged. In addition, as the values of MT and ST, “0” means a normal temperature, “1” means an excessively high temperature, and “2” means a low temperature.

In addition, as reference values for determining the values of the above-mentioned flags, a first high temperature, a first low temperature, a first overcharge SoC, a first over-discharge SoC, etc. may be set in advance in relation to the first high voltage battery MB, and a second high temperature, a second low temperature, a second overcharge SoC, a second over-discharge SoC, etc. may be set in advance in relation to the second high voltage battery SB.

That is, when the first SoC is equal to or greater than the first overcharge SoC, 1 may be given to the MS, and, when the first SoC is less than or equal to the first over-discharge SoC, 2 may be given to the MS. In addition, when the first temperature is equal to or higher than the first high temperature, 1 may be given to the MT, and, when the first temperature is lower than or equal to the first low temperature, 2 may be given to the MT. Meanwhile, when the second SoC is equal to or greater than the second overcharge SoC, 1 may be given to the SS, and, when the second SoC is less than or equal to the second over-discharge SoC, 2 may be given to the SS. In addition, when the second temperature is equal to or higher than the second high temperature, 1 may be given to the ST, and, when the second temperature is lower than or equal to the second low temperature, 2 may be given to the ST.

Referring to FIG. 4, the process of determining the values of the above-mentioned flags according to this embodiment will be described in order.

First, at S10, when the first SoC is equal to or greater than the first overcharge SoC, 1 may be assigned to the MS, and the process may move on to S30. Otherwise, the process may move on to S20.

At S20, when the first SoC is less than or equal to the first over-discharge SoC, 2 may be assigned to the MS, otherwise, 0 may be assigned to the MS, and the process may move on to S30.

At S30, when the first temperature is equal to or greater than the first high temperature, 1 may be assigned to the MT, and the process may move on to S50. Otherwise, the process may move on to S40.

At S40, when the first temperature is less than or equal to the first low temperature, 2 may be given to the MT, otherwise, 0 may be assigned to the MT, and the process may move on to S50.

At S50, when the second SoC is equal to or greater than the second overcharge SoC, 1 may be assigned to the SS, and the process may move on to S70. Otherwise, the process may move on to S60.

At S60, when the second SoC is less than or equal to the second over-discharge SoC, 2 may be assigned to the SS, otherwise, 0 may be assigned to the SS, and the process may move on to S70.

At S70, when the second temperature is equal to or greater than the second high temperature, 1 may be assigned to the ST, otherwise, the process may move on to S80.

At S80, when the second temperature is less than or equal to the second low temperature, 2 may be assigned to the ST, otherwise, 0 may be assigned to the ST.

After the respective states of the batteries have been examined, the integrated state thereof may be examined at S3.

At S3, when either the MS or the SS is given 1 and the sum of the first SoC and the second SoC is greater than the sum of a set first SoC overcharge threshold and a set second SoC overcharge threshold, the value of the MS or the SS may be corrected so that both the MS and the SS are given 1.

In addition, at S3, when one of the MS and the SS is given 2 while the other is given o and the sum of the first SoC and the second SoC is less than the sum of a set first SoC over-discharge threshold and a set second SoC over-discharge threshold, the value of the MS or the SS may be corrected so that both the MS and the SS are given 2.

Next, at S4, the first controller Ctrl 1 may determine the prioritized mode to be first performed as conditioning control.

According to this embodiment, the modes of conditioning control may include a first mode, a second mode, a third mode, and a fourth mode, which will be described below, and the mode to be performed first among the modes may be determined at S4.

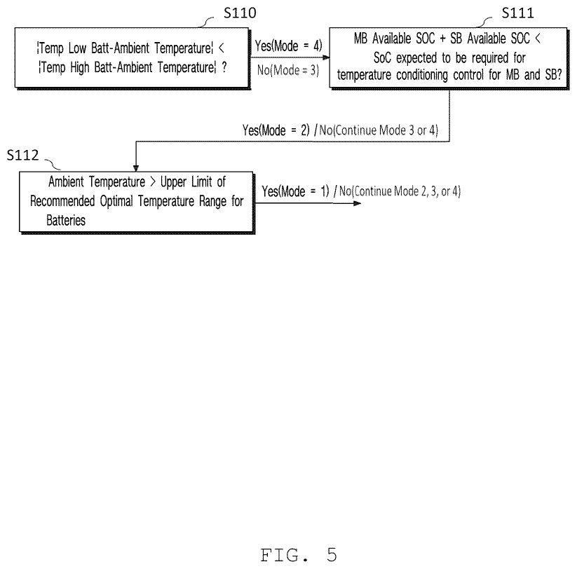

FIG. 5 shows how a mode to be first performed is determined, which will be described below.

First, at S110, when the absolute value of the difference between the temperature of the battery of the flag given 2 among the MT and the ST (a first temperature or a second temperature) and the ambient temperature is less than the absolute value of the difference between the temperature of the battery of the flag given 1 among the MT and the ST (a first temperature or a second temperature) and the ambient temperature, the fourth mode may be selected as the mode to be first performed, otherwise, the third mode may be selected as the mode to be first performed (a first decision).

Next, at S111, when the sum of the available SoC of the first high voltage battery MB and the available SoC of the second high voltage battery SB is less than the SoC expected to be required for conditioning control, the mode to be first performed may be switched to the second mode, otherwise, the first decision may be maintained (a second decision). Here, the available SoC may be the value obtained by subtracting the minimum SoC set to be maintained to maintain the functions of the battery from the current SoC.

Thereafter, at S112, when the ambient temperature is above the optimal temperature range of the first high voltage battery MB and/or the second high voltage battery SB, the mode to be first performed may be switched to the first mode, otherwise, the second decision may be maintained (a third decision).

Referring back to FIG. 3, the first controller Ctrl 1 may determine a control target for conditioning control at S5 following S4.

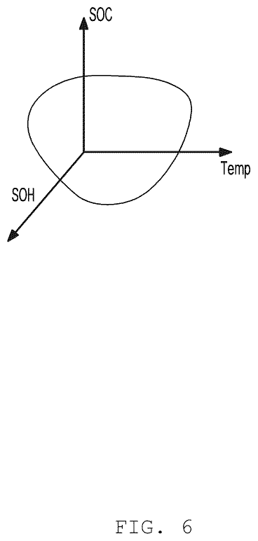

FIG. 6 conceptually shows the SoC-SoH-temperature map for the first high voltage battery MB and/or the second high voltage battery SB, and the map data as shown in FIG. 6 may be used for determining a control target.

The map data may include one or more empirical or theoretical formulas and/or lookup tables.

Referring to FIG. 6, temperature may become a control target based on a state of Health (SoH) and a SoC, and a SoC may become a control target based on a SoH and temperature.

For example, on the map data, when a SoC is high or a SoH is low, temperature may be determined to be low.

The first controller Ctrl 1 may start conditioning control in the mode to be first performed at S6 following S5.

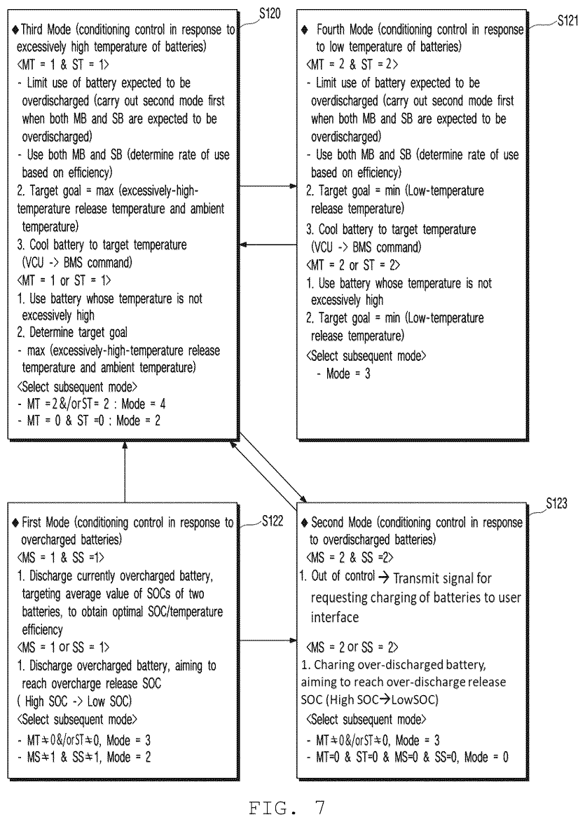

According to this embodiment, there are the four modes for conditioning control as shown in FIG. 7 and each mode will be described below.

### The First Mode

Conditioning control mode applied when at least one of the MS and the SS is given 1.
Including control for charging and discharging between the first high voltage battery MB and the second high voltage battery SB, targeting the average value of the first SoC and the second SoC, when both the MS and the SS are given 1 and/or control for discharging the other battery, targeting the overcharge release SoC set for the battery given 1 among the first high voltage battery MB and the second high voltage battery SB, when either the MS or the SS is given 1 (the overcharge release SoC may be determined based on the map data as shown in FIG. 6).

### The Second Mode

Conditioning control mode applied when at least one of the MS and the SS is given 2.
Including control for transmitting a signal for requesting charging to a user interface (e.g., an AVN screen) when both the MS and the SS are given 2 and/or control for charging the other battery, targeting the over-discharge release SoC set for the battery corresponding to the flag given 2 among the first high voltage battery MB and the second high voltage battery SB, when either the MS or the SS is given 2 (the over-discharge release SoC may be determined based on the map data as shown in FIG. 6).

### The Third Mode

Conditioning control mode applied when at least one of the MT and the ST is given 1.
Including control for cooling the first high voltage battery MB and the second high voltage battery SB to an excessively-high-temperature release temperature, which has been set in advance, or ambient temperature using the power of the first high voltage battery MB and the second high voltage battery SB when both the MT and the ST are given 1 and/or control for cooling the other battery to the excessively-high-temperature release temperature or the ambient temperature using the power of the battery other than the battery corresponding to the flag given 1 among the first high voltage battery MB and the second high voltage battery SB when either the MT or the ST is given 1 (the excessively-high-temperature release temperature may be determined based on the map data as shown in FIG. 6).

### The Fourth Mode

Conditioning control mode applied when at least one of the MT and the ST is given 2.
Including control for heating the first high voltage battery MB and the second high voltage battery SB to a low-temperature release temperature, which has been set in advance, or ambient temperature using the power of the first high voltage battery MB and the second high voltage battery SB when both the MT and the ST are given 2 and/or control for heating the other battery to the low-temperature release temperature or the ambient temperature using the power of the battery other than the battery corresponding to the flag given 2 among the first high voltage battery MB and the second high voltage battery SB when either the MT or the ST is given the flag value corresponding to a low temperature (the low-temperature release temperature may be determined based on the map data as shown in FIG. 6).

According to this embodiment, it goes without saying that each of the first high voltage battery MB and the second high voltage battery SB may include a cooling mechanism and a heating mechanism for control for cooling and heating.

For example, examples of the cooling mechanism may include at least one of a blower for air cooling, a coolant passage for water cooling, and a coolant pump for water cooling.

In addition, examples of the heating mechanism may include an electric heater, for example.

After each of the above-described modes has been carried out, steps S2 and S3 of FIG. 3 may be repeated to update the flag values, and a subsequent mode may be determined and carried out based on the updated flag values.

As shown in FIG. 7, after the first mode has been carried out, the third mode may be selected as a subsequent mode when at least one of the updated MT and the updated ST is not given 0, and the second mode may be selected as a subsequent mode when both the updated MS and the updated SS are not given 1.

After the second mode has been carried out, the third mode may be selected as a subsequent mode when at least one of the updated MT and the updated ST is not given 0, and the conditioning control may end when all of the updated MT, the updated ST, the updated MS, and the updated SS are given 0.

After the third mode has been carried out, the fourth mode may be selected as a subsequent mode when at least one of the updated MT and the updated ST is given 2, and the second mode may be selected as a subsequent mode when both the updated MT and the updated ST are given 0.

After the fourth mode has been carried out, the third mode may be selected as a subsequent mode.

Referring to FIG. 7, after the third mode has been carried out at S120, the process may move on to S121 when the fourth mode is selected as a subsequent mode, and the process may move on to S123 when the second mode is selected as a subsequent mode.

In addition, after the fourth mode has been carried out at S121, the process may move on to S120 when the third mode is selected as a subsequent mode.

After the first mode has been carried out at S122, the process may move on to S120 when the third mode is selected as a subsequent mode, and the process may move on to S123 when the second mode is selected as a subsequent mode.

Furthermore, after the second mode has been carried out at S123, the process may move on to S120 when the third mode is selected as a subsequent mode, and the conditioning control may end when all the updated flag values are o.

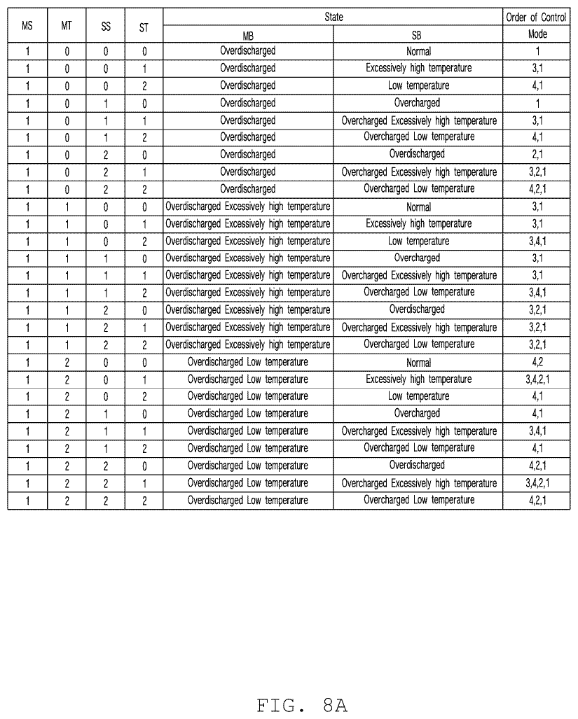

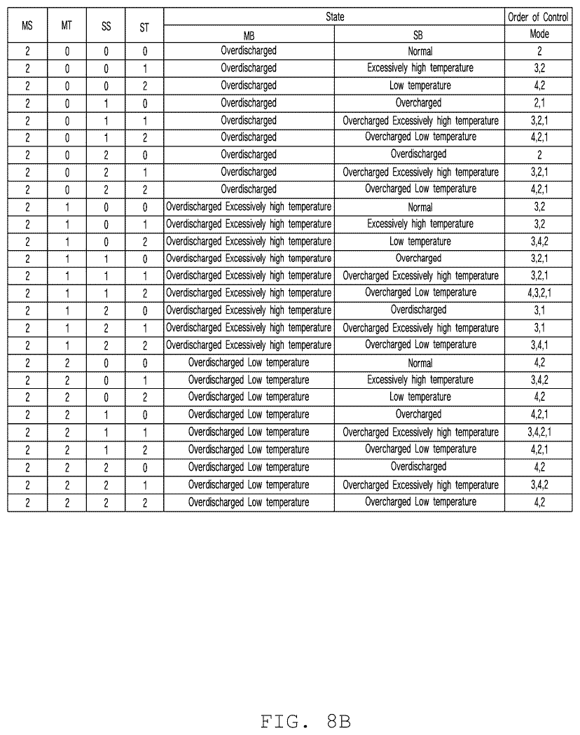

FIGS. 8A and 8B illustrate flag values and corresponding modes determined based on the states of the first high voltage battery MB and the second high voltage battery SB according to an embodiment of the present disclosure.

As shown in FIGS. 8A and 8B, there are 54 possible combinations of the states of the first high voltage battery MB and the second high voltage battery SB. FIGS. 8A and 8B illustrate the MS, the MT, the SS, and the ST for each combination, control modes therefor, and the order in which the control modes are carried out.

Referring to FIGS. 8A and 8B, according to this embodiment, even though there are so many possible combinations of the states of the two batteries due to the dual battery system of the first high voltage battery MB and the second high voltage battery SB, the conditioning control may be possible for all the combinations.

The exemplary embodiments of the present disclosure have been shown and described, but the present disclosure is not limited to the specific embodiments described above. It is needless to say that various modifications can be made to the present disclosure within the gist of the present disclosure claimed in the appended claims by a person having ordinary skill in the art, and such modifications should not be understood separately from the technology of the present disclosure.

The foregoing descriptions of the specific exemplary embodiments of the present disclosure have been presented for the purposes of illustration and description. They are not intended to be exhaustive or to limit the present disclosure to the precise forms disclosed, and obviously many modifications and variations are possible in light of the above-described teachings. The exemplary embodiments were chosen and described to explain certain principles of the embodiments of the present disclosure and their practical application, to enable others skilled in the art to make and utilize the various exemplary embodiments of the present disclosure, as well as various alternatives and modifications thereof. It is intended that the scope of the present disclosure be defined by the claims appended hereto and their equivalents.

What is claimed is:

1. A mobility apparatus comprising:
a plurality of wheels;
at least one driving motor configured to provide driving force to the wheels;
a first battery configured to supply power to the at least one driving motor; and
a controller configured to control the at least one driving motor and the first battery, wherein, in a state in which a second battery is detachably electrically connected to the first battery through a DC/DC converter, the controller is configured to perform a prioritized mode among a plurality of modes for battery conditioning control to be performed first based on states of the first battery and the second battery to carry out the battery conditioning control.

2. The mobility apparatus of claim 1, wherein the controller is configured to perform the prioritized mode among the plurality of modes for the battery conditioning control by an examination of the states of the first battery and the second battery or an integrated state of the first battery and the second battery.

3. The mobility apparatus of claim 2, wherein the examination of the states of the first battery and the second battery or the integrated state comprises the examination of the states based on a first state of charge (SoC) and a first temperature of the first battery and a second SoC and a second temperature of the second battery.

4. The mobility apparatus of claim 3, wherein the examination of the states based on the first SoC and the first temperature of the first battery and the second SoC and the second temperature of the second battery comprises assignment of a flag value to each of a flag for the first SoC (MS), a flag for the first temperature (MT), a flag for the second SoC (SS), and a flag for the second temperature (ST).

5. The mobility apparatus of claim 4, wherein:
the flag values of the MS and the SS include values each corresponding to being normal, being overcharged, or being over-discharged; and
the flag values of the MT and the ST include values each corresponding to a normal temperature, an excessively high temperature, or a low temperature.

6. The mobility apparatus of claim 5, wherein:
in a case in which the examination of the states shows that either the MS or the SS is assigned the value corresponding to being overcharged and the examination of the integrated state shows that a sum of the first SoC and the second SoC is greater than a sum of a set first SoC overcharge threshold and a set second SoC overcharge threshold, the assignment of the flag value comprises a correction of the flag value of the MS or the SS so that both the MS and the SS are assigned the value corresponding to being overcharged; or
in a case in which the examination of the states shows that one of the MS and the SS is assigned the value corresponding to being over-discharged while the other of the MS and the SS is assigned the value corresponding to being normal and the examination of the integrated state shows that the sum of the first SoC and the second SoC is less than a sum of a set first SoC over-discharge threshold and a set second SoC over-discharge threshold, the assignment of the flag value comprises a correction of the flag value of the MS or the SS so that both the MS and the SS are assigned the value corresponding to being over-discharged.

7. The mobility apparatus of claim 6, wherein the plurality of modes comprises at least two of a first mode for the battery conditioning control applied in a case in which at least one of the MS and the SS is assigned the value corresponding to being overcharged, a second mode for the battery conditioning control applied in a case in which at least one of the MS and the SS is assigned the value corresponding to being over-discharged, a third mode for the battery conditioning control applied in a case in which at least one of the MT and the ST is assigned the value corresponding to the excessively high temperature, and a fourth mode for the battery conditioning control applied in a case in which at least one of the MT and the ST is assigned the value corresponding to the low temperature.

8. The mobility apparatus of claim 7, wherein the first mode comprises:
in a case in which both the MS and the SS are assigned the value corresponding to being overcharged, control for charging and discharging between the first battery and the second battery to target an average value of the first SoC and the second SoC; and
in a case in which either the MS or the SS is assigned the value corresponding to being overcharged, control for discharging the battery among the first battery and the second battery that is assigned the value corresponding to being overcharged to the other battery among the first battery and the second battery to target a set overcharge release SoC.

9. The mobility apparatus of claim 8, wherein, in the case in which either the MS or the SS is assigned the value corresponding to being overcharged, the set overcharge release SoC is determined based on an SoC-SoH-temperature data set for the battery that is assigned the value corresponding to being overcharged.

10. The mobility apparatus of claim 7, wherein the second mode comprises:
in a case in which both the MS and the SS are assigned the value corresponding to being over-discharged, control for transmitting a signal for requesting charging to a user interface; and
in a case in which either the MS or the SS is assigned the value corresponding to being over-discharged, control for charging the battery among the first battery and the second battery that is assigned the value corresponding to being over-discharged from the other battery among the first battery and the second battery to target an over-discharge release SoC.

11. The mobility apparatus of claim 10, wherein the over-discharge release SoC is determined based on an SoC-SoH-temperature data set for the battery among the first battery and the second battery that is assigned the value corresponding to being over-discharged.

12. The mobility apparatus of claim 7, wherein the third mode comprises:
in a case in which both the MT and the ST are assigned the value corresponding to an excessively high temperature, control for cooling the first battery and the second battery to a set excessively-high-temperature release temperature or an ambient temperature using power of the first battery and the second battery; and
in a case in which only one among the MT and the ST is assigned the value corresponding to the excessively high temperature, control for cooling the battery among the first battery and the second battery to the set excessively-high-temperature release temperature or the ambient temperature using power of the other battery among the first battery and the second battery that is not assigned the value corresponding to the excessively high temperature.

13. The mobility apparatus of claim 12, wherein the set excessively-high-temperature release temperature is determined based on an SoC-SoH-temperature data set for the battery among the first battery and the second battery that is assigned the value corresponding to the excessively high temperature.

14. The mobility apparatus of claim 7, wherein the fourth mode comprises:
in a case in which both the MT and the ST are assigned the value corresponding to the low temperature, control for heating the first battery and the second battery to a set low-temperature release temperature or an ambient temperature using power of the first battery and the second battery; and
in a case in which either the MT or the ST is assigned the value corresponding to the low temperature, control for heating the battery among the first battery and the second battery to the set low-temperature release temperature or the ambient temperature using power of the other battery of the first battery and the second battery that is not assigned the value corresponding to the low temperature.

15. The mobility apparatus of claim 14, wherein the set low-temperature release temperature is determined based on an SoC-SoH-temperature data set for the battery among the first battery and the second battery that is assigned the value corresponding to the low temperature.

16. The mobility apparatus of claim 7, wherein:
the controller is configured to perform the prioritized mode among the plurality of modes for the battery conditioning control by an update of the values of the MT, the MS, the ST, and the SS and is configured to perform a subsequent mode based on the updated values after the prioritized mode;
after the first mode has been carried out, the third mode is selected as the subsequent mode in a case in which at least one of the updated MT and the updated ST is not assigned the value corresponding to the normal temperature, and the second mode is selected as the subsequent mode in a case in which neither the updated MS nor the updated SS is assigned the value corresponding to being overcharged;
after the second mode has been carried out, the third mode is selected as the subsequent mode in a case in which at least one of the updated MT and the updated ST is not assigned the value corresponding to the normal temperature, and the battery conditioning control ends in a case in which all of the updated MT, the updated ST, the updated MS, and the updated SS are assigned the value corresponding to being normal;
after the third mode has been carried out, the fourth mode is selected as the subsequent mode in a case in which at least one of the updated MT and the updated ST is assigned the value corresponding to the low temperature, and the second mode is selected as the subsequent mode in a case in which both the updated MT and the updated ST are assigned the value corresponding to the normal temperature; and
after the fourth mode has been carried out, the third mode is selected as the subsequent mode.

17. The mobility apparatus of claim 7, wherein:
the controller is configured to perform the prioritized mode among the plurality of modes for the battery conditioning control by a determination of the prioritized mode;
the determination of the prioritized mode comprises:
a first decision in which, in a case in which an absolute value of a difference between a temperature of the battery assigned the flag value corresponding to the low temperature among the MT and the ST and an ambient temperature is less than an absolute value of a difference between a temperature of the battery assigned the flag value corresponding to an excessively high temperature among the MT and the ST and the ambient temperature, the fourth mode is selected as the mode to be first performed, and otherwise, the third mode is selected as the mode to be first performed;
a second decision in which, after the first decision has been made, in a case in which a sum of an available SoC of the first battery and an available SoC of the second battery is less than an amount of the SoC expected to be required for the battery conditioning control, the mode to be first performed is switched to the second mode, and otherwise, the first decision is maintained; and
a third decision in which, after the second decision has been made, in a case in which the ambient temperature is above an optimal temperature range set for the first battery or the second battery, the mode to be first performed is switched to the first mode, and otherwise, the second decision is maintained.

18. A method of performing battery conditioning control for a mobility apparatus, the mobility apparatus comprising a plurality of wheels, at least one driving motor configured to provide driving force to the wheels, a first battery configured to supply power to the at least one driving motor, and a controller configured to control the at least one driving motor and the first battery, the method comprising:
in a case in which a second battery is detachably electrically connected to the first battery through a DC/DC converter, performing, by the controller, a prioritized mode among a plurality of modes for the battery conditioning control based on states of the first battery and the second battery to carry out the battery conditioning control.

19. The method of claim 18, wherein performing the prioritized mode among the plurality of modes for the battery conditioning control comprises examining the states of the first battery and the second battery or an integrated state of the first battery and the second battery.

20. A mobility apparatus detachably connected to another mobility apparatus, the another mobility apparatus comprising a plurality of first wheels, at least one first driving motor configured to provide driving force to the plurality of first wheels, a first battery configured to supply power to the at least one first driving motor, and a first controller configured to control the at least one driving motor and the first battery, the mobility apparatus comprising:
a second battery detachably electrically connected to the first battery and a second controller, wherein, in a case in which the second battery is electrically connected to the first battery through a DC/DC converter, the second controller is configured to perform a prioritized mode among a plurality of modes for battery conditioning control based on states of the first battery and the second battery to carry out the battery conditioning control.
